(19) United States
(12) Patent Application Publication
(10) Pub. No.: US 2016/0362775 A1
(43) Pub. Date: Dec. 15, 2016

(54) Multi-Phase Pre-Reacted Thermal Barrier Coatings and Process Therefor

(71) Applicant: UNITED TECHNOLOGIES CORPORATION, Hartford, CT (US)

(72) Inventors: Kathryn Sarah Read, Colchester, CT (US); Elisa M Zaleski, Manchester, CT (US); Mario P Bochiechio, Vernon, CT (US)

(21) Appl. No.: 14/865,038

(22) Filed: Sep. 25, 2015

Related U.S. Application Data
(60) Provisional application No. 62/058,047, filed on Sep. 30, 2014.

(51) Int. Cl. C23C 4/11; F01D 5/28; C23C 4/18; C23C 4/134; C23C 4/02

(52) U.S. Cl. CPC C23C 4/11; C23C 4/134; C23C 4/02; C23C 4/18; F01D 5/288; F05D 2220/32; F05D 2300/611

(57) ABSTRACT

A process for coating a component including applying a thermal barrier coating material to a bond coat and selectively infiltrating a blocking material into the thermal barrier coating material.

### CROSS REFERENCE TO RELATED APPLICATION

This application claims the benefit of provisional application Ser. No. 62/058,047, filed Sep. 30, 2014.

### BACKGROUND

The present disclosure relates to thermal barrier coating (TBC) compositions designed to withstand infiltration from molten environmental contaminant infiltration, processes for applying same, and components coated with same.

Gas turbine engines typically include a compressor to pressurize airflow, a combustor to burn a hydrocarbon fuel in the presence of the pressurized air, and a turbine to extract energy from the resultant combustion gases. The combustor and the turbine form the hot section of the engine and components therein often include a thermal barrier coating.

Thermal insulation provided by the TBC enables hot section components to survive higher operating temperatures and can increase both component and engine durability. The TBC is typically a refractory ceramic material deposited on a bond coat to form what may be termed a TBC system. Bond coat materials widely used in TBC systems include oxidation-resistant overlay coatings such as MCrAlX (where M is iron, cobalt and/or nickel, X is yttrium or another rare earth element, and Hf, Si or other transition metal elements can be added as minor constituents), and diffusion coatings such as diffusion aluminides that contain aluminum intermetallics.

Ceramic materials and particularly binary yttria-stabilized zirconia (YSZ) are widely used as TBC materials because of their high temperature capability, low thermal conductivity, and relative ease of deposition such as by air plasma spraying (APS), flame spraying such as high-velocity oxy-fuel (HVOF), physical vapor deposition (PVD) and other techniques.

Under service conditions, these TBC coated hot section engine components can be susceptible to various modes of damage, including erosion, oxidation and corrosion from exposure to the gaseous products of combustion, foreign object damage and attack from environmental contaminants. Contaminants including Calcium Magnesium Alumino-Silicate (CMAS), Volcanic Ash, Fly Ash, and others can adhere to the TBC surfaces of the hot section components. CMAS particulate is often contained in the atmosphere as fine sand and/or dust. The interaction between the TBC and contaminants may result in premature TBC loss over the life of the components.

CMAS infiltration is a phenomenon that is linked to premature TBC spallation. CMAS may melt on the hot section components during the turbine operation and penetrate the strain tolerant porosity of the TBC microstructure. Upon cooling, this penetrated layer stiffens and the induced strain energy can lead to premature TBC spallation.

Rare earth zirconates are often utilized to react with the encroaching CMAS melt which may decrease the depth and rate of infiltration of the melt and hence the strain energy introduced into the coating to delay premature coating spallation. However, formation of this reaction layer is not readily controllable in service, as a number of extrinsic factors such as CMAS deposition rate, surface temperatures, airflow, erosion of the TBC, and foreign object damage may result in variation in penetration depth and the potential resultant damage.

Some alternative coating chemistries based on the Lanthanide series rare earth oxides (La (57) to Lu (71), such as gadolinium zirconate (GdZr) can form an apatite phase when exposed to certain environmental contaminants. A high temperature apatite phase is capable of reducing the rate of degradation of the TBC in service compared to other coatings such as yittria-stabilized zirconica (YSZ). The development of mechanical property tests (such as modulus, flexural strength, etc.) to evaluate the behavior of TBCs when attacked by environmental contaminants has been limited by the inability to infiltrate the actual environmental contaminants into the system without causing premature spallation of the TBC.

Conventional processes using environmental contaminant chemicals have been primarily focused on the addition of chemicals in a powder or liquid form. The thermal processing required to infiltrate the TBC involves temperatures greater than 2150° F. to fully infiltrate the TBC for testing purposes. When cooled from an isothermal hold at these temperatures, the TBC can experience spallation, including complete separation from the metallic substrate, due to the relatively large mismatch between the coefficients of thermal expansion between the ceramic top coat and the underlying substrate and the lower toughness of the ceramic top coat.

### SUMMARY

A process for coating a component according to one disclosed non-limiting embodiment of the present disclosure includes selectively infiltrating a blocking material into the thermal barrier coating material.

A further embodiment of the present disclosure includes, wherein the blocking material is infiltrated into the thermal barrier coating material to a depth less than 50 microns.

A further embodiment of any of the foregoing embodiments of the present disclosure includes removing a carrier of the blocking material.

A further embodiment of any of the foregoing embodiments of the present disclosure includes, wherein removing the carrier of the blocking material is effectuated via a “green run” that is typical of gas turbine engine initial runs.

A further embodiment of any of the foregoing embodiments of the present disclosure includes, wherein removing the carrier of the blocking material is effectuated via a heat treat process.

A further embodiment of any of the foregoing embodiments of the present disclosure includes, wherein removing the carrier of the blocking material is effectuated during the formation of high temperature silicates such as a rare-earth apatite phase.

A further embodiment of any of the foregoing embodiments of the present disclosure includes, wherein the blocking material is formed via one of Suspension Plasma Spray (SPS) and Suspension Precursor Plasma Spray (SPPS) to form the exposed surface.

A further embodiment of any of the foregoing embodiments of the present disclosure includes, wherein the blocking material is a filled pre-ceramic polymer resin.

A further embodiment of any of the foregoing embodiments of the present disclosure includes, wherein the blocking material is an unfilled pre-ceramic polymer resin.

A further embodiment of any of the foregoing embodiments of the present disclosure includes, wherein selectively infiltrating a blocking material into the thermal barrier coating material forms a multi-phase pre-reacted surficial region.

A further embodiment of any of the foregoing embodiments of the present disclosure includes, wherein the blocking material is a filled sacrificial polymer resin carrier.

A further embodiment of any of the foregoing embodiments of the present disclosure includes, wherein the blocking material includes a filler material and a carrier.

A further embodiment of any of the foregoing embodiments of the present disclosure includes, wherein the filling material is a volcanic ash powder.

A further embodiment of any of the foregoing embodiments of the present disclosure includes, wherein the filling material is a calcium magnesium alumino silicate (CMAS) based compound.

A further embodiment of any of the foregoing embodiments of the present disclosure includes, wherein the carrier is one of ethanol, jet fuel, polymer resin, and water.

A process for coating a component according to another disclosed non-limiting embodiment of the present disclosure includes selectively infiltrating a blocking material including carrier, and which may include a filler, into a thermal barrier coating material; and removing the carrier.

A further embodiment of any of the foregoing embodiments of the present disclosure includes, wherein the blocking material is infiltrated into the thermal barrier coating material to a depth of less than about 50 microns.

A gas turbine engine component according to another disclosed non-limiting embodiment of the present disclosure includes a superalloy substrate; a bond coat on the substrate; a thermal barrier coating material on the bond coat; and a blocking material infiltrated into the thermal barrier coating material to a depth up to about 10 microns.

A further embodiment of any of the foregoing embodiments of the present disclosure includes, wherein the blocking material includes at least one of a filled pre-ceramic polymer resin, an unfilled pre-ceramic polymer resin, and a filled sacrificial polymer resin carrier.

A further embodiment of any of the foregoing embodiments of the present disclosure includes, wherein the blocking material includes a carrier of at least one of, ethanol, jet fuel, polymer resin, and water.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of an example gas turbine engine architecture;

FIG. 2 is a flowchart of a process according to one disclosed non-limiting embodiment for application of a coating system to a component;

FIG. 3 is a cross-section through the coating system applied in accords with the process of FIG. 2.

### DETAILED DESCRIPTION

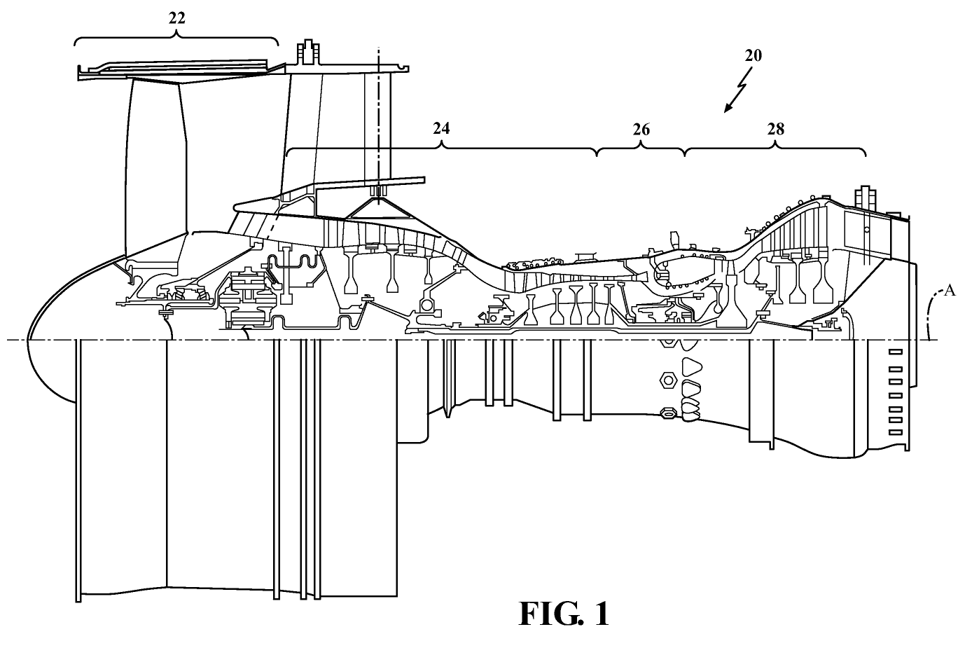

FIG. 1 schematically illustrates a gas turbine engine 20. The gas turbine engine 20 is disclosed herein as a two-spool turbo fan that generally incorporates a fan section 22, a compressor section 24, a combustor section 26 and a turbine section 28. The fan section 22 drives air along a bypass flowpath while the compressor section 24 drives air along a core flowpath for compression and communication into the combustor section 26 then expansion through the turbine section 28. Although depicted as a turbofan in the disclosed non-limiting embodiment, it should be understood that the concepts described herein are not limited to use with turbofans as the teachings may be applied to other types of turbomachinery to include, but not be limited to, low bypass augmented turbofans, turbojets, turboshafts, three-spool (plus fan) turbofans and industrial gas turbines.

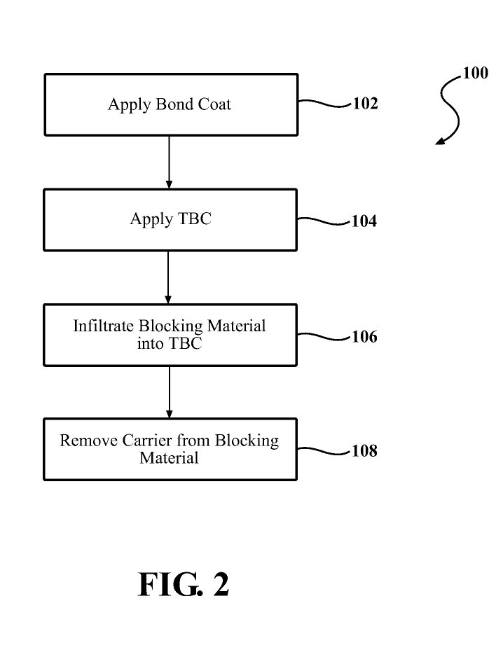

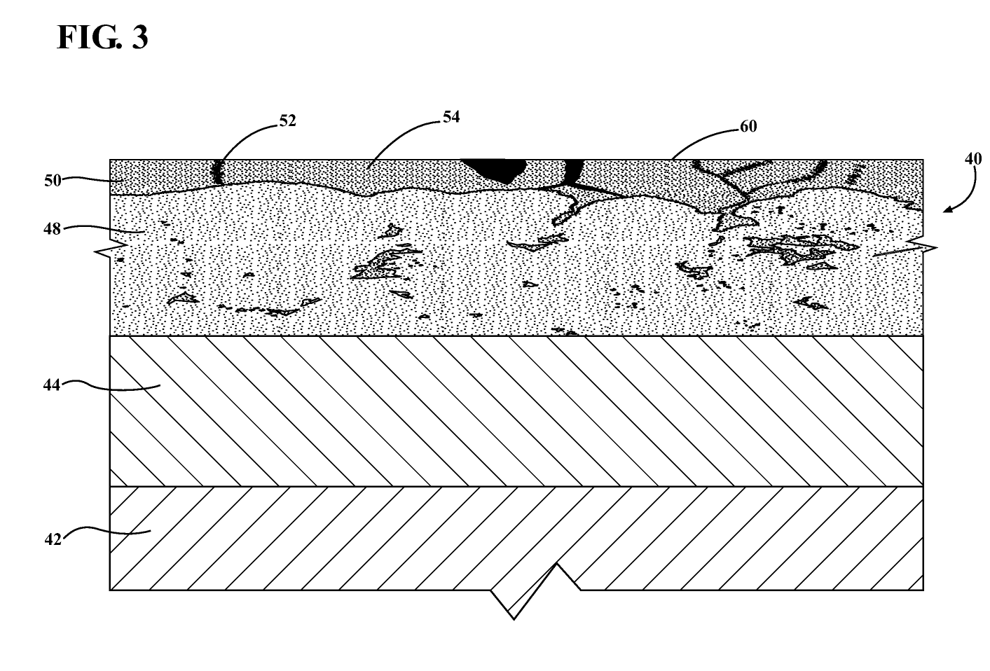

With reference to FIG. 2, a process 100 according to one disclosed non-limiting embodiment for application of a coating system 40 to a component 42 (FIG. 3) subjected to high temperatures is schematically represented. The steps of the process 100 are schematically disclosed in terms of functional block diagrams as a flowchart. It should be appreciated that alternative of addition steps may be provided without departing from the teaching herein.

Representative examples of the component 42 include but are not limited to combustor section 26 and/or turbine section 28 hardware such as augmentor components, combustor liners, blades, vanes, and blade outer air seals. The coating system 40 as described herein is suitable for protection of a substrate 42 such as a superalloy but while being described with reference to such superalloy gas turbine engine components, the teachings herein are generally applicable to any component on which a Thermal Barrier Coating (TBC) may be used to protect the component from a high temperature environment, particularly environments containing CMAS.

The coating system 40, in one disclosed non-limiting embodiment is manufactured by the process 100 which initially includes application of a bond coat 44 on the substrate 42 (step 102 and FIG. 3). The bond coat 44 may include an aluminum-rich composition, such as an overlay coating or a diffusion coating such as a diffusion aluminide or a diffusion platinum aluminide according to formulas such as MCrAlY, MCrAlY+Hf, and MCrAlY+HF+Si, in which M denotes nickel, cobalt, iron, platinum or mixtures thereof; Cr denotes chromium; Al denotes aluminum; and Y denotes yttrium. MCrAlY materials are often referred to as overlay coatings because they are applied in a predetermined composition and do not interact significantly with the substrate 42 during the deposition process. One example preferred MCrAlY bond coat composition has a weight percent compositional range of 5-40 Cr, 8-35 Al, 0.1-2.0 Y, 0.1-7 Si, 0.1-2.0 Hf, balance selected from the group consisting of Ni, Co and mixtures thereof. Alternatively or in addition the bond coat material may include Al, PtAl and the like, that are often referred to as diffusion coatings. Alternatively or in addition, the bond coat material may also include Al, PtAl, MCrAlY as described above, and the like, that are often referred to as cathodic arc coatings.

The bond coat 44 may be applied by any method operable to produce a dense, uniform, adherent coating of the desired composition, such as, but not limited to, an overlay bond coat, diffusion bond coat, cathodic arc bond coat, etc. Such techniques may include, but are not limited to, diffusion processes (e.g., inward, outward, etc.), low pressure plasma-spray, air plasma-spray, sputtering, cathodic arc, electron beam physical vapor deposition, high velocity plasma spray techniques (e.g., HVOF, HVAF), combustion processes, wire spray techniques, laser beam cladding, electron beam cladding, etc.

The particle size for the bond coat 44 may be of any suitable size, and in may be between about 15 microns (0.015 mm) and about 60 microns (0.060 mm) with a mean particle size of about 25 microns (0.025 mm). The bond coat 44 may be applied to any suitable thickness, and may be about 5 mils (0.127 mm) to about 10 mils (0.254 mm) thick. In some embodiments, the thickness may be about 6 mils (0.152 mm) to about 7 mils (0.178 mm) thick.

Next, a thermal barrier coating material 48 (FIG. 3), often referred to as a top coat, may be applied to the bond coat 44 (step 104). The thermal barrier coating material 48 may include a ceramic based compound. Representative thermal barrier coating materials include, but are not limited to: a stabilized zirconate, a stabilized hafnate, combinations including at least one of the foregoing compounds, and the like, for example, yttria stabilized zirconia, calcia stabilized zirconia, magnesia stabilized zirconia, yttria stabilized hafnia, calcia stabilized hafnia and magnesia stabilized hafnia. Yttria stabilized zirconia is commercially available as 7YSZ. One example preferred thermal barrier coating material 48 is a zirconia stabilized by between 6-8 wt % yttria that is about 0.05-5 mil (0.00127-0.127 mm) in thickness deposited, nominally at 1-3 mil (0.0254-0.0761 mm).

The thermal barrier coating material 48 may be applied by various known methods. Suitable application methods include, but are not limited to, physical vapor deposition (e.g., electron beam), thermal spray (e.g., air plasma, high velocity oxygen fuel), sputtering, sol gel, slurry, combinations comprising at least one of the foregoing application processes, and the like.

Next, a blocking material 50 is selectively infiltrated into the thermal barrier coating material 48 to form an exposed surface 60 (step 106; FIG. 2). In one disclosed non-limiting embodiment, the blocking material 50 includes a filler material 52 within a carrier 54. Examples of the blocking material 50 include, but are not limited to, filled or unfilled pre-ceramic polymer resins, filled sacrificial polymer resin carriers, or combinations thereof. Examples of the filler materials 52 include, but are not limited to, pre-reacted volcanic ash powder, calcium magnesium alumino silicate (CMAS), other environmental contaminants, such as vanadates and sulfur compounds, ceramic nano-particles, and other particles ranging from 0.1-10 um, and metal organic compounds within a carrier 54 such as a polymer resin, ethanol, jet fuel, and water that forms a solution, suspension, or colloid. For example, the polymer resin operates as a jet fuel or water carrier and the filler may be the same materials listed. The ceramic precursor polymers are capable of conversion to a ceramic upon sufficient heat treatment as well as conversion to a phase such as a rare-earth silicate.

Common methodologies for infiltrating a polymeric based, pre-ceramic or otherwise, blocking material 50 into a porous solid form would include, but are not limited to, vacuum, temperature, and pressure assisted processes that may improve the natural filling obtained by capillary forces. A common embodiment of such a process could involve dipping or submerging a porous system 40 in a bath of polymer resin allowing infiltration into the structure. Controlling the exposure time and the temperature of the process could enable selective infiltration to partial depths. This process would then be followed by appropriate heat treatments to enable the conversion of the system to the desired phase.

An alternative deposition methodology for the blocking material 50 includes Suspension Plasma Spray (SPS) or Suspension Precursor Plasma Spray (SPPS) which facilitate a wide range of chemistries and microstructures to simultaneously optimize cost and strain tolerance. SPS is a form of plasma spraying where the ceramic feedstock is dispersed in a liquid suspension before being injected into the plasma jet which facilities deposition of finer microstructures through the use of finer powders. SPPS is a solution based process by which a solution of soluble metal cations is injected into a plasma plume. For SPS, the source material for the blocking material 50 may be provided as sub-micron particles dispersed in alcohol, water, or another suitable carrier. For SPPS the source material for the blocking material 50 may be provided as metal salts or metal-organic compounds that would be dispersed in alcohol, water, or other suitable carrier, i.e., Calcium Nitrate+Tetra-ethyl-ortho-silicate+rare earth nitrate in an alcohol solution.

The carrier 54 of the blocking material 50 is then removed (step 108) to form a second phase that alters the thermal barrier coating material 48 with an essentially pre-sealed structure. The blocking material 50 is infiltrated into the thermal barrier coating material 48 to a depth of, for example, about 10 microns (0.39 mil; 0.01 mm). The carrier 54 can be removed via, for example, an engine “green run” heat treat procedure, to react the materials to form the desirable stable, high temperature, ceramic phase such as a rare-earth apatite. That is, the carrier 54 can be removed during manufacture and/or initial testing operations, i.e., “green run” that is typical of gas turbine engine initial operations.

The process 100 provides for selective infiltration, into the thermal barrier coating material 48 to form multi-phase material layer coating system 40. The coating system 40 forms a multi-phase pre-reacted surficial region, to mitigate or completely eliminate damage to thermal barrier coating material 48 by CMAS or other contaminants on hot section gas turbine engine components.

Potential uses of the altered thermal barrier coating material 48 include, but are not limited to, improving the environmental contaminant resistance of altered thermal barrier coating material 48 coated components through the formation of the multi-phase pre-reacted surficial region, subsequently improving the temperature capability of the altered thermal barrier coating material 48, and evaluating the mechanical properties of potentially compromised (contaminated) altered thermal barrier coating material 48 structures.

The modifications of the material proposed should not be limited to altered thermal barrier coating material 48 and may be applicable to any porous ceramic or metallic material for the above described purposes, among others.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, repeated any number of times, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A process for coating a component, comprising:
applying a bond coat on a substrate of the component;
applying a thermal barrier coating material to the bond coat; and
selectively infiltrating a blocking material into the thermal barrier coating material.

2. The process as recited in claim 1, wherein the blocking material is infiltrated into the thermal barrier coating material to a depth of less than about 50 microns.

3. The process as recited in claim 1, further comprising removing a carrier of the blocking material.

4. The process as recited in claim 3, wherein removing the carrier of the blocking material is effectuated via a “green run.”

5. The process as recited in claim 3, wherein removing the carrier of the blocking material is effectuated via a heat treat process.

6. The process as recited in claim 3, wherein removing the carrier of the blocking material is effectuated during the formation of high temperature rare-earth silicate phases, such as apatite.

7. The process as recited in claim 1, wherein the blocking material is formed via one of Suspension Plasma Spray (SPS) and Suspension Precursor Plasma Spray (SPPS) to form an exposed surface.

8. The process as recited in claim 1, wherein the blocking material is a filled pre-ceramic polymer resin.

9. The process as recited in claim 1, wherein the blocking material is an unfilled pre-ceramic polymer resin.

10. The process as recited in claim 1, wherein selectively infiltrating a blocking material into the thermal barrier coating material forms a multi-phase pre-reacted surficial region.

11. The process as recited in claim 1, wherein the blocking material is a filled sacrificial polymer resin carrier.

12. The process as recited in claim 1, wherein the blocking material includes a filler material and a carrier.

13. The process as recited in claim 12, wherein the filling material is a pre-reacted volcanic ash powder.

14. The process as recited in claim 12, wherein the filling material is a calcium magnesium alumino silicate (CMAS) based compound.

15. The process as recited in claim 12, wherein the carrier is one of ethanol, jet fuel, polymer resin, and water.

16. A process for coating a component, comprising:
selectively infiltrating a blocking material including a filler material and a carrier into a thermal barrier coating material; and
removing the carrier material.

17. The process as recited in claim 16, wherein the blocking material is infiltrated into the thermal barrier coating material to a depth of less than about 50 microns.

18. A gas turbine engine component, comprising:
a superalloy substrate;
a bond coat on the substrate;
a thermal barrier coating material on the bond coat; and
a blocking material infiltrated into the thermal barrier coating material to a depth of less than about 50 microns.

19. The component as recited in claim 18, wherein the blocking material includes at least one of a filled or unfilled pre-ceramic polymer resin, and a filled sacrificial polymer resin carrier.

20. The component as recited in claim 18, wherein the blocking material includes a carrier of at least one of, ethanol, jet fuel, polymer resin, and water.
